(19) United States
(12) Patent Application Publication
(10) Pub. No.: US 2011/0266487 A1
(43) Pub. Date: Nov. 3, 2011

(54) CELLULAR POLYESTER MADE OF POST-CONSUMER FLAKES AND THE USE OF PRODUCTS MADE THEREOF

(75) Inventors: Mika MELLER, Jarvenpaa (FI); Jie LI, Zofingen (CH); Justyna DOLEGA, Wroclaw (PL); Horst GRÄTER, Muenster (DE)

(73) Assignee: Armacell Enterprise GmbH, Muenster (DE)

(21) Appl. No.: 12/770,142

(22) Filed: Apr. 29, 2010

(51) Int. Cl. C08J 11/04; E04B 1/88

(52) U.S. Cl. 252/62; 521/48

(57) ABSTRACT

Manufacturing of polyester based expanded materials made mostly of pre-cleaned and compounded post-consumer polyester by increasing the intrinsic viscosity (IV) during an extrusion process is described. By careful selection of processing conditions and parameters, it is possible to obtain low density polyester foam material with good cellular structure and under stable processing conditions.

### BACKGROUND OF THE INVENTION

1. Field of the Invention

This invention relates to manufacturing of polyester based expanded materials made of pre-cleaned and compounded post-consumer polyester by increasing the intrinsic viscosity (IV) during an extrusion process, the manufacturing of such materials and the use of products made thereof.

2. Description of the Background Art

The term “post consumer” is defined as material being brought back into the process—i.e. being recycled—after its prior use, e.g. as PET bottles.

Expanded polyester polymers, i.e. polyester foam or sponge, are of major importance for a large number of applications related to insulation against temperature gradients, noise shielding, vibration damping, lightweight construction etc. Foaming of polyesters and the use of post-consumer polyester are rather new technologies, and only limited numbers of prior art can be found.

M&G Polimeri describes (EP 0866089) that significantly higher than standard intrinsic viscosity (IV) resin (IV>1.2 ml/g) is required for physical foaming of polyester, especially when lower densities are targeted. A high viscosity is required in order to build up necessary pressure for foaming to occur and to prevent cell collapse.

Traditionally solid state polymerization is used to increase the molecular weight and hence viscosity to the required level.

The re-use of post consumer polyester material is not novel. For example molded solid and high density sheets have been made by using post consumer raw materials.

CH686082 and JP2000169613 describe the manufacturing of such products, but limited to molded products due to the low intrinsic viscosity of post consumer polyesters achievable during such processes.

Furthermore blends of post consumer polyester material, polypropylene and fillers have been used to make this polyester foamable (see JP2001129867), but the possible quantity of post consumer polyester is very limited.

JP2003165861 describes the expansion of polyester resins using post consumer material but limited to the use of chemical blowing agents under the additional term of using a thickening agent <=20 g/10 min in melt flow rate (MFR) to increase the intrinsic viscosity to the required level.

All these processes do not allow the use of high amounts of post-consumer polyester and/or lead to worse mechanical properties compared to virgin polyester materials.

Some work was even done to improve the intrinsic viscosity of post consumer polyester by solid state polymerization, e.g. U.S. Pat. No. 6,130,261 describes the recycling of polyester foam by densification and afterwards drying the material, but the process takes several hours, limited to expanded polyester as base materials.

It is widely known that extrusion reduces the intrinsic viscosity by mechanical and thermal degradation of polyesters which is detrimental for foaming. That makes it quite difficult to use post-consumer polyester, especially for foaming processes which require high intrinsic viscosities.

### SUMMARY OF THE INVENTION

In accordance with one embodiment of the present invention, an expanded, cellular material comprising at least 50 wt % of post-consumer polyester resin whereby the intrinsic viscosity of the polymer(s) is upgraded during the foam extrusion process and the intrinsic viscosity of the exiting foam is characterized being higher than 1.2 ml/g, preferably above 1.35 ml/g and the density is between 40 and 200 kg/m³, preferably between 50 and 150 kg/m³.

### DETAILED DESCRIPTION OF THE INVENTION

It has now unexpectedly found out that an additional extrusion step of post-consumer polyester prior to the foam extrusion process results in superior foams, equal to foams made of virgin polyester.

In order to achieve this, post consumer polyester has to be pre-cleaned from dust and moisture and afterwards compounded and filtered in an extruder. During this step moisture and oxygen can be exhausted by melt degassing to prevent the material of further oxidative and hydrolytic degradation. Additionally chain extending additives can be added to increase the intrinsic viscosity. Afterwards the material is granulated.

During the subsequent foam extrusion chain extending additives need to be added to raise the intrinsic viscosity to a level above 1.2 ml/g. Further additives, e.g. nucleating agents, fillers, flame retardants etc. can be added to adjust the properties of the foam.

This invention focused on foaming a resin or a blend of resins, where most of the polymer consisted of post consumer material, such as washed PET bottle flakes. Different types of post consumer sources were evaluated and used in different levels. During this work a reactive additive (RA) that increases the viscosity by chain extension and side chain branching during extrusion (described as chain extending concentrate in European patent application 09 006 678.8) has been used. The chemistry of this package is described in more detail in the said patent application.

In all below trials, a modified twin-screw extruder from Berstorff was used. The extruder was equipped with special screws made for PET foaming, having compressive ratio larger than 2.0, and L/D larger than 28. Furthermore reversed elements need to be used in order to prevent gas escape backwards from injection area. In addition, the feeding pipe used in dosing station was equipped with vibrating device where the vibration frequency could be controlled. This enabled consistent feeding of amorphous post-consumer polyester bottle flakes, and prevented bridging of the material.

Physical blowing agent was injected after the melting zone under high pressure, and consequently the melt was mixed by means of screw elements and static mixer. The level of blowing agent was adjusted to achieve the target density. The mixture of blowing agent and polymer was cooled during extrusion close to crystallization point and sufficient pressure was maintained by controlling the viscosity of the resin and the temperature of the mixture.

The reactive additive (RA) was used in different levels to adjust the viscosity and pressure to a sufficient level (typically min. 60 bars measured in the extruder head). As the mixture exited the extruder, the rapid pressure drop caused rapid foaming of the polymer, whereby the cell size was controlled by level of special nucleating agent: Nucleating agent could be an inorganic material, in this case a talc containing masterbatch, organic material or gaseous material. Furthermore a flame retardant additive, such as phosphate, halogen, borate, melamine or similar containing component may be used for applications where fire retardancy is required. The foam was then cooled down and later analyzed in the laboratory. All raw materials were dried to contain moisture below 100 ppm prior to feeding into the extruder.

In this invention post consumer flakes that have significantly lower starting IV have been used, where by means of reactive foam extrusion the IV of the polymer is increased in a single step to a satisfactory level while at the same time a physical blowing agent is introduced to the mixture. As the mixture exits the extruder, the IV has reached level superior to 1.2 ml/g, and consequently by sudden pressure drop the physical blowing agent rapidly expands and foaming takes place.

### Comparative Example 1

Commercially available PET resin from Sabic (BC-112) was fed into the extruder with throughput of 400 kg/hr together with the previously mentioned reactive additive (RA) and a nucleating agent (NA). Physical blowing agent was adjusted to a level that would result in final product having density of 100 kg/m³. At an RA level of 3.4 wt % and NA level of 2.5 wt % very nice foam with homogeneous cell structure and uniform rectangular shape was obtained. The virgin PET resin was characterized of having an average MFR of 38.3 g/10 min at 260° C. using 2.16 kg weight (die with L=8 mm and D=2.095 mm).

### Comparative Example 2

The comparative example 1 was repeated, but replacing BC-112 material with post consumer flakes from RE-PET. The polymer was fed into the in the extruder with throughput of 400 kg/hr together with the reactive additive (RA) and the nucleating agent (NA). Physical blowing agent was adjusted to a level that would result in final product having density of 100 kg/m³. The process was found very unstable, mostly due to dosing problems and huge variations in reactivity of the additive (RA was used in level of 6.5% and NA at level of 2.5%). Foam was obtained, but visually it did not look good, containing some collapsed areas, and in average larger cells than from example 1. Furthermore the shape was not rectangular, but collapsed from the middle. Additionally it was noticed that the extruder die was partially blocked after a short time due to impurities present in the post consumer flakes, which partially caused the uneven cellular structure.

### Comparative Example 3

Granulated post-consumer PET material from PTP (PET-M) was fed into the extruder with throughput of 400 kg/hr together with the reactive additive (RA) and the nucleating agent (NA). Physical blowing agent was adjusted to a level that would result in final product having density of 100 kg/m³. The RA level was kept the same as in comparative example 2 (6.5 wt %). Poor looking foam, with significant cell collapse and rough surface characteristic was obtained and pressures were low in the extruder.

### Comparative Example 4

Comparative example 3 was repeated but with RA level of 8.0 wt %. The pressure in the extruder remained low and only an unsatisfactory foam quality was obtained (slightly improved from example 3).

### Innovative Example 1

The recipe from Example 3 was used, but 15 wt % of PET-M was replaced by virgin resin BC-112. Immediately the viscosity increased to sufficient level and good looking foam with uniform cell structure and rectangular shape was obtained by using RA at the level of 6.5 wt %. The process was found quite stable.

### Innovative Example 2

Post consumer flakes from RE-PET were compounded and filtered at an external compounding company as received using an twin-screw extruder at 300 rpm. The granulated material had an average MFR of 261 g/10 min at 260° C. using 2.16 kg weight.

### Innovative Example 3

Post consumer flakes from RE-PET were compounded and filtered at an external compounding company using a twin-screw extruder which was equipped with vacuum port and screw speed was set at 150 rpm. Also the material was pre-cleaned from dust and moisture prior to compounding. The granulated material had an average MFR of 33.3 g/10 min at 260° C. using 2.16 kg weight.

### Innovative Example 4

Post consumer flakes from RE-PET were compounded and filtered at an external compounding company using a twin-screw extruder with vacuum port and a screw speed of 150 rpm (as in innovative example 3). In addition a relatively low level of reactive additive (RA=1.5 wt %) was compounded with the flakes. The granulated material had an average MFR of 14.3 g/10 min at 260° C. using 2.16 kg weight.

### Innovative Example 5

The granulated raw material according to innovative example 2 was fed into the extruder with throughput of 400 kg/hr together with the reactive additive (RA) and the nucleating agent (NA). Physical blowing agent was adjusted to a level that would result in final product having density of 100 kg/m³. RA was adjusted to level of 8.0 wt %, the NA at level of 2.5 wt % and the process was found unstable with high pressure variations and poor looking foam was obtained. The foam was characterized having larger than usual average cell size and a rough surface, which can be linked to pre-foaming of the material.

### Innovative Example 6

The granulated raw material according to innovative example 3 was fed into the extruder with throughput of 400 kg/hr together with the reactive additive (RA) and the nucleating agent (NA). Physical blowing agent was adjusted to a level that would result in final product having density of 100 kg/m³. RA was adjusted to level of 6.5 wt %, the NA at level of 2.5 wt % and very nice looking foam was obtained, characterized by uniform cell structure and an almost rectangular shape. The process was found quite stable under these conditions, with some variations in pressure.

### Innovative Example 7

The granulated raw material according to innovative example 4 was fed into the extruder with throughput of 400 kg/hr together with RA and the nucleating agent (NA). Physical blowing agent was adjusted to a level that would result in final product having density of 100 kg/m³. At RA level of 5.5 wt % the extrusion process was found very stable and the foam looked identical to the foam obtained from Comparative example 1.

### Innovative Example 8

A foam according to Innovative example 7 was manufactured, where additionally two different flame retardants were mixed with the recipe, more specifically 5 wt % of Exolit 950 and 1 wt % of Mastertek 372815 were used. Furthermore the blowing agent was adjusted to a higher level so that a density of 70 kg/m³ (±5%) was achieved. The foam looked very good, having slightly larger cells than obtained in Innovative example 7, and the process was found stable. The foam was characterized of having B2 classification according to DIN 4102 and E-class according to ISO 11925.

1. A expanded, cellular material comprising at least 50 wt % of post-consumer polyester resin whereby the intrinsic viscosity of the polymer(s) is upgraded during the foam extrusion process and the intrinsic viscosity of the exiting foam is characterized being higher than 1.2 ml/g, preferably above 1.35 ml/g and the density is between 40 and 200 kg/m³, preferably between 50 and 150 kg/m³.

2. The expanded, cellular material according to claim 1, comprising less than 50 wt % of virgin polyester resin, and wherein the intrinsic viscosity of the exiting foam is characterized being higher than 1.4 ml/g.

3. The expanded, cellular material according to claim 1, wherein the physical blowing agent is either a hydrocarbon, fluorocarbon, argon, nitrogen, CO₂, or a mixture thereof.

4. The expanded, cellular material according claim 1 which further comprises a flame retardant or a mixture of flame retardants to improve the fire properties.

5. The expanded, cellular material according to claim 1 which further comprises nucleating agents and fillers.

6. A process for producing an expanded, cellular material according to claim 1, wherein the post-consumer polyester resin is carefully cleaned, compounded and filtered in an extruder and afterwards granulated.

7. The process according to claim 6, wherein the intrinsic viscosity of the post-consumer polyester resin is higher than 0.6 ml/g, preferably higher than 0.65 ml/g, and the post-consumer resin is upgraded by means of reactive extrusion during the compounding process.

8. The process according to claim 6, wherein a chain extending additive is added.

9. The process according to claim 6, wherein a subsequent foam extrusion is conducted with chain extending additives.

10. The process according to claim 6, wherein nucleating agents and fillers are added.

11. An article comprising the foam according to claim 1.

12. A method of at least one of thermal and acoustic insulation, comprising insulating an area with an article according to claim 11.

13. The method of claim 11, wherein said article is utilized for at least one of kitting purposes, construction purposes, core foams for highly loaded, high durable products, core foams for windmill blades, building elements, panels, tiles, wall elements, roof elements, ceiling elements, floor elements, building profiles, stud profiles, or window profiles.
